(19) United States
(12) Patent Application Publication
(10) Pub. No.: US 2019/0025581 A1
(43) Pub. Date: Jan. 24, 2019

(54) HEAD UP DISPLAY APPARATUS AND MANUFACTURING METHOD OF SAME

(71) Applicant: DENSO CORPORATION, Kariya-city, Aichi-pref (JP)

(72) Inventor: Takahiro NAMBARA, Kariya-city (JP)

(73) Assignee: DENSO CORPORATION, Kariya-city, Aichi-pref (JP)

(21) Appl. No.: 16/071,918

(22) PCT Filed: Oct. 21, 2016
(86) PCT No.: PCT/JP2016/081199

§ 371 Date: Jul. 23, 2018

(30) Foreign Application Priority Data
Jan. 26, 2016 (JP) 2016-012761

(51) Int. Cl. G02B 27/01; B60K 35/00; B60R 1/00

(52) U.S. Cl. CPC G02B 27/0101; B60K 35/00; B60R 2300/205; B60K 2350/2052; G02B 2027/0192; B60R 1/00

(57) ABSTRACT

A HUD apparatus is mounted to a vehicle and displays a virtual image visible to an occupant by projecting an image onto a windshield. The HUD apparatus includes multiple illumination units arrayed one another and providing illumination, and an image forming portion having an illumination target surface and forming the image when the respective illumination units illuminate corresponding spots on the illumination target surface. Each illumination unit has a light emitting element emitting illumination light with an emission angle distribution, according to which emission intensity reaches maximum in a peak direction and decreases with distance from the peak direction, and a condensing portion located face-to-face with the light emitting element and capturing a part of radiant flux including light in the peak direction PD from illumination light and collimating the captured part of radiant flux by condensing the captured part of radiant flux.

### CROSS REFERENCE TO RELATED APPLICATION

This application is based on Japanese Patent Application No. 2016-12761 filed on Jan. 26, 2016, the disclosure of which is incorporated herein by reference.

### TECHNICAL FIELD

The present disclosure relates to a head up display apparatus (hereinafter, referred to as a HUD apparatus for short) mounted to a mobile object and displaying a virtual image visible to an occupant.

### BACKGROUND ART

An existing HUD apparatus is mounted to a mobile object and displays a virtual image visible to an occupant. A HUD apparatus disclosed in Patent Literature 1 includes multiple illumination units arrayed with respect to one another and providing illumination, and an image forming portion having an illumination target surface and forming an image when the respective illumination units illuminate corresponding spots on the illumination target surface.

Each illumination unit has a light emitting element emitting illumination light, and a condensing portion located face-to-face with the light emitting element and condensing illumination light.

### PRIOR TECHNICAL LITERATURE

### Patent Literature

Patent Literature 1: JP-A-2007-108429

However, Patent Literature 1 discloses neither an emission angle distribution of the light emitting element nor a detailed condensing function furnished to the condensing portion for illumination light emitted from the light emitting element. It is therefore difficult to reduce non-uniform luminance by efficiently using light emitted from the light emitting element.

### SUMMARY OF INVENTION

It is an object of the present disclosure to provide a HUD apparatus capable of efficiently reducing non-uniform luminance of a virtual image. Another object of the present disclosure is to provide a manufacturing method of a HUD apparatus.

According to one aspect of the present disclosure, a head up display apparatus is configured to be mounted to a mobile object and to display a virtual image visible to an occupant by projecting an image onto a projection member. The head up display apparatus comprises a plurality of illumination units arrayed one another and configured to provide illumination. The head up display apparatus further comprises an image forming portion having an illumination target surface and configured to form the image when the respective illumination units illuminate corresponding spots on the illumination target surface. Each illumination unit includes a light emitting element configured to emit illumination light with an emission angle distribution, according to which emission intensity reaches maximum in a peak direction and decreases with distance from the peak direction. Each illumination unit further includes a condensing portion located face-to-face with the light emitting element and configured to capture a part of radiant flux including light in the peak direction from illumination light and to collimate the captured part of radiant flux by condensing the captured part of radiant flux.

According to one aspect of the present disclosure, a manufacturing method is for a head up display apparatus configured to be mounted to a mobile object and to display a virtual image visible to an occupant by projecting an image onto a projection member. The head up display apparatus includes a plurality of illumination units, which are arrayed one another to provide illumination, and an image forming portion, which has an illumination target surface and configured to form the image when the respective illumination units illuminate corresponding spots on the illumination target surface. Each illumination unit includes a light emitting element, which is configured to emit illumination light with an emission angle distribution according to which emission intensity reaches maximum in a peak direction and decreases with distance from the peak direction. Each illumination unit further includes a condensing portion, which is located face-to-face with the light emitting element and configured to capture a part of radiant flux including light in the peak direction from illumination light and to collimate the captured part of radiant flux by condensing the captured part of radiant flux. The manufacturing method comprises setting, in an F-number setting step, an F-number of the condensing portion according to the emission angle distribution of the light emitting element in an array of the illumination units. The manufacturing method further comprises setting, in a unit number setting step, a total number of the illumination units according to the F-number to illuminate the illumination target surface entirely by the array of the illumination units.

### BRIEF DESCRIPTION OF THE DRAWINGS

The above and other objects, features and advantages of the present disclosure will become more apparent from the following detailed description made with reference to the accompanying drawings. In the drawings:

The above and other objects, configurations, and advantages of the present disclosure will become more apparent from the following detailed description taken in conjunction with the accompanying drawings, in which:

FIG. 1 is a schematic view showing a HUD apparatus of a first embodiment mounted to a vehicle;

FIG. 2 is a schematic view showing an array of illumination units of the first embodiment;

FIG. 3 is a graph showing an emission angle distribution of a light emitting element of the first embodiment;

FIG. 4 is a schematic view showing a simple configuration of one of the illumination units of FIG. 2;

FIG. 5 is a schematic view showing a simple configuration of the array of the illumination units of FIG. 2;

FIG. 6 is a view showing condensing portions of FIG. 5 by dividing each into a first lens element and a second lens element;

FIG. 7 shows a simulation image indicating luminance across an illumination target surface when an F-number of the condensing portion is 0.5 in the first embodiment;

FIG. 8 shows a simulation image indicating luminance across the illumination target surface when the F-number of the condensing portion is 0.7 in the first embodiment;

FIG. 9 shows a simulation image indicating luminance across the illumination target surface when the F-number of the condensing portion is 1.0 in the first embodiment;

FIG. 10 is a graph showing a luminance distribution across the illumination target surface in cross section in an array direction;

FIG. 11 is a flowchart depicting a manufacturing method of the HUD apparatus of the first embodiment;

FIG. 12 is a view corresponding to FIG. 5 in a second embodiment; and

FIG. 13 is a schematic view showing an array of illumination units of a third modification.

### DESCRIPTION OF EMBODIMENTS

Hereinafter, several embodiments of the present disclosure will be described with reference to the drawings. Similar components in respective embodiments below may be labeled with same reference numerals and a description may not be repeated where appropriate. When a configuration is described only in part in the respective embodiments below, a configuration described in any preceding embodiment applies to the rest of the configuration. In addition to a combination of configurations explicitly described in any embodiment, configurations of two or more embodiments can be combined partially even when such a combination is not explicitly described unless a trouble arises from such a combination.

### First Embodiment

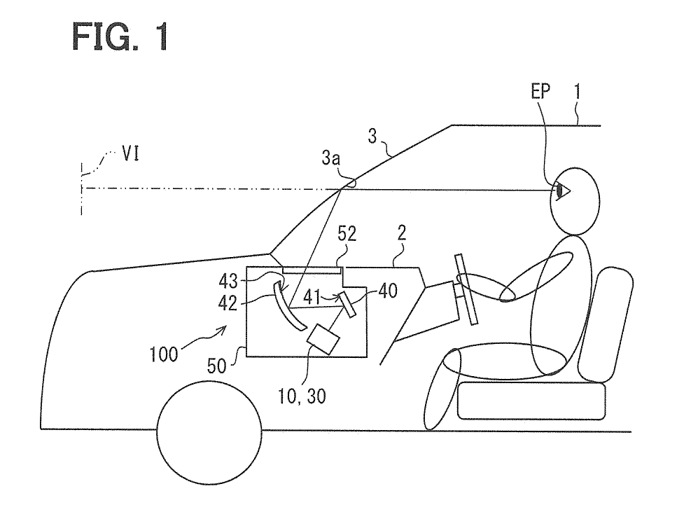

As shown in FIG. 1, a HUD apparatus 100 according to a first embodiment of the present disclosure is mounted to a vehicle 1, which is one type of a mobile object, and stored in an instrument panel 2. The HUD apparatus 100 projects an image onto a windshield 3 of the vehicle 1 used as a projection member. Accordingly, the HUD apparatus 100 displays a virtual image visible to an occupant of the vehicle 1. That is, light of the image reflected on the windshield 3 reaches an eye point EP of the occupant in a compartment of the vehicle 1 and the occupant senses the light. The occupant thus becomes able to recognize various types of information displayed as a virtual image VI. Examples of various types of information displayed as a virtual image VI include but not limited to vehicle state values, such as a vehicle speed and a remaining amount of fuel, and vehicle information, such as road information and view supplemental information.

The windshield 3 of the vehicle 1 is made of light-transmitting glass, synthetic resin, or the like and formed in a plate shape. A surface of the windshield 3 on a compartment side forms a smooth inwardly-curved or flat projection surface 3a, on which an image is projected. Alternatively, a combiner available separately from the vehicle 1 may be installed inside the vehicle 1 as a projection member and an image may be projected onto the combiner instead of the windshield 3.

A specific configuration of the HUD apparatus 100 as above will be described according to FIGS. 1 through 6 in the following. The HUD apparatus 100 includes multiple illumination units 10, an image forming portion 30, a planar mirror 40, and a concave mirror 42, all of which are stored and held in a housing 50.

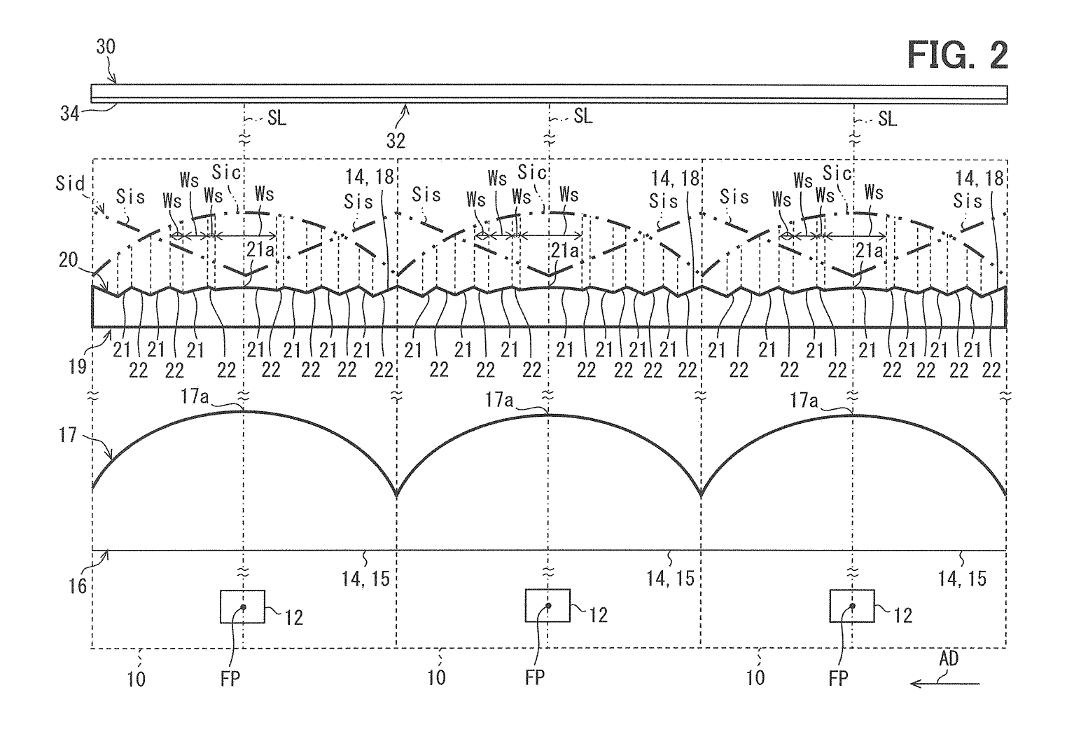

As is shown in FIG. 2, the multiple illumination units 10 are arrayed with respect to one another. In the present embodiment, in particular, three illumination units 10 arrayed in one array direction AD are provided. Each illumination unit 10 has a light emitting element 12 and a condensing portion 14.

The light emitting element 12 of the illumination unit 10 is a light-emitting diode element generating less heat. The light emitting element 12 is located on a light-source circuit board and electrically connected to a power supply via a wiring pattern on the circuit board. More specifically, the light emitting element 12 is formed by encapsulating a blue light-emitting diode element on a chip in a yellow fluorescent material prepared by mixing light-transmitting synthetic resin with a yellow fluorescent agent. Blue light emitted from the blue light-emitting diode element according to an amount of current excites the yellow fluorescent material to emit yellow light, and false-white illumination light as a mixture of blue light and yellow light is emitted.

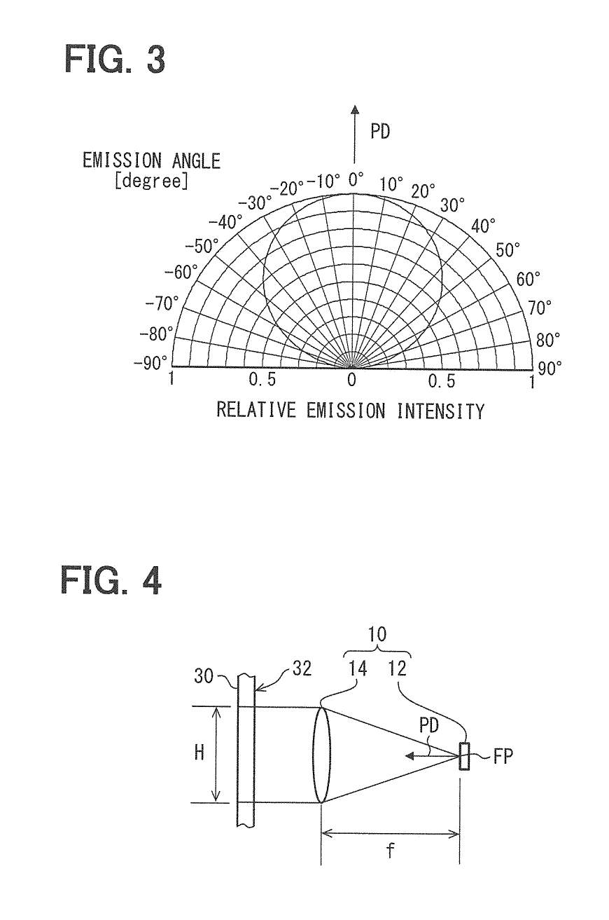

The light emitting element 12 emits illumination light with an emission angle distribution as is shown in FIG. 3, according to which emission intensity reaches maximum in a peak direction PD and decreases relatively with distance from the peak direction PD.

As is shown in FIG. 2, the condensing portion 14 is provided to make a pair with the light emitting element 12 and located face-to-face with the light emitting element 12 in the illumination unit 10. To be more specific, the condensing portion 14 of the first embodiment is a lens group having two lens elements 15 and 18.

The first lens element 15 is a condensing element made of light-transmitting synthetic resin, glass or the like, and located on one side of the condensing portion 14 where the light emitting element 12 is present. The first lens element 15 is provided with a smooth, planar incoming-side refractive surface 16 on one side where the light emitting element 12 is present. Also, the first lens element 15 is provided with a smooth, outwardly-curved outgoing-side refractive surface 17 on the other side where the second lens element 18 is present.

The first lens elements 15 each as a single part are provided integrally with an array of the illumination units 10 and thereby form a lens array.

The second lens element 18 is a condensing element made of light-transmitting synthetic resin, glass, or the like and located on the other side of the condensing portion 14 where the image forming portion 30 is present. The second lens element 18 is provided with a smooth, planar incoming-side refractive surface 16 on one side where the first lens element 15 is present. Also, the second lens element 18 is provided with a composite optical surface 20 refracting illumination light on the other side where the image forming portion 30 is present.

The composite optical surface 20 is provided across an entire surface of the second lens element 18. The composite optical surface 20 forms an alternating array structure, in which condensing surfaces 21 and deflection surfaces 22 continue alternately.

The condensing surface 21 is formed as one of divided regions of a virtual condensing surface Sic divided in the array direction AD by a predetermined dividing width Ws. The virtual condensing surface Sic is a smooth, outwardly-curved surface protruding toward the image forming portion 30.

The deflection surface 22 is formed as one of divided regions of a virtual defection surface Sid divided in the array direction AD by a predetermined dividing width Ws. The virtual defection surface Sid is made up of multiple slopes Sis alternately switching to inverse gradients at every point corresponding to a surface vertex of the virtual condensing surface Sic. Each slope Sis is a smooth plane in the present embodiment. A gradient of the slope Sis is set inversely to a gradient of a corresponding region of the virtual condensing surface Sic.

The dividing widths Ws with which to divide the condensing surface 21 and the deflection surface 22 into regions are set variously. However, by setting the dividing widths Ws to make a sag amount substantially constant between the two surfaces, a thickness of the entire second lens element 18 is made constant. By arraying the condensing surfaces 21 and the deflection surfaces 22 alternately, a shape of a part of the virtual condensing surface Sic and a shape of a part of the virtual defection surface Sid are extracted and reproduced on the composite optical surface 20. In FIG. 2, dimensions are indicated for some of the dividing widths Ws.

The condensing surfaces 21 collimate illumination light by condensing the illumination light whereas the deflection surfaces 22 deflect illumination light to a side opposite to refraction by the condensing surfaces 21.

Some of the condensing surfaces 21 include a surface vertex of the virtual condensing surface Sic, and a surface vertex 21a of each of such condensing surfaces 21 is located on a straight line SL linking the corresponding light emitting element 12 and a surface vertex 17a of the outgoing-side refraction surface 17 of the corresponding first lens element 15. The straight line SL is substantially orthogonal to the array direction AD. The second lens elements 18 each as a single part are provided integrally with an array of the illumination units 10 and thereby form a composite Fresnel lens array.

The light emitting element 12 is located on a focal point FP of the condensing portion 14. More specifically, let f be a focal length of the condensing portion 14, which is a synthetic focal length of the two lens elements 15 and 18 (that is, a distance from a principal plane PC to the focal point, see also FIG. 6). Then, for the light emitting element 12 located as above, an error up to 10% of the focal length f is allowed in a direction along the straight line SL and an error up to 5% of the focal length f is allowed in the array direction AD. In addition, the light emitting element 12 is formed to emit illumination light with the peak direction PD set along the straight line SL.

Owing to the installation locations and the configurations of the light emitting element 12 and the condensing portion 14 in the illumination unit 10 as described above and an F-number set in the condensing portion 14, the condensing portion 14 captures a part of radiant flux including light in the peak direction PD from illumination light and collimates the captured part of radiant flux by condensing the captured part of radiant flux. The collimated light is emitted along the straight line SL and hence a light path along the straight line SL is formed in the illumination unit 10.

More specifically, let Fmin be an F-number to condense illumination light within a distribution range in which emission intensity of the light emitting element 12 is at or above a first predetermined ratio (50% in the present embodiment) of emission intensity in the peak direction PD as a part of radiant flux. Also, let Fmax be an F-number to condense illumination light within a distribution range in which emission intensity of the light emitting element 12 is at or above a second predetermined ratio higher than the first predetermined ratio (90% in the present embodiment) of emission intensity in the peak direction PD as a part of radiant flux. Then, an F-number of the condensing portion 14 is in a range from Fmin to Fmax both inclusive. A definition of an F-number in the present embodiment will be described below.

The emission angle distribution of the light emitting element 12 of the present embodiment is set forth in FIG. 3. Hence, it is found from FIG. 3 that relative emission intensity is 0.5 is at an angle of about ±60 degrees. Accordingly, when Fmin is set as an F-number, the condensing portion 14 captures illumination light in a range from −60 degrees to +60 degrees as a part of radiant flux. Also, it is found from FIG. 3 that relative emission intensity is 0.9 at an angle of about ±20 degrees. Accordingly, when Fmax is set as an F-number, the condensing portion 14 captures illumination light in a range from −25 degrees to +25 degrees as a part of radiant flux.

The illumination unit 10 providing illumination in the manner as above collimates a part of radiant flux as described above and illuminates a corresponding spot on the illumination target surface 32 substantially orthogonal to the straight line SL in the image forming portion 30.

As is shown in FIG. 1, the image forming portion 30 of the present embodiment is a liquid crystal panel using TFTs (Thin Film Transistors), for example, an active-matrix liquid crystal panel made up of multiple liquid crystal pixels arrayed in two dimensional directions. In the image forming portion 30, a pair of polarization plates, a liquid crystal layer sandwiched between a pair of the polarization plates, and so on are laminated. The polarization plates have a property to transmit light with an electric field vector pointing in a predetermined direction and absorb light with an electric field vector pointing in a direction substantially perpendicular to the predetermined direction. A pair of the polarization plates is located to be substantially orthogonal to the predetermined direction. The liquid crystal layer is capable of twisting a polarization direction of light incident on the liquid crystal layer according to an applied voltage when a voltage is applied to the liquid crystal pixels one by one.

The image forming portion 30 is thus capable of forming an image when light is incident on the illumination target surface 32, which is a panel surface on a side where the illumination units 10 are present, by controlling transmittance of the light at each liquid crystal pixel. Color filters of colors (for example, red, green, and blue) different from each other are provided to adjacent liquid crystal pixels and various colors are attained by combining the color filters.

The entire illumination target surface 32 is illuminated when the respective illumination units 10 illuminate corresponding spots on the illumination target surface 32. In the present embodiment, by arraying three illumination units 10 in one array direction AD, a rectangular image with a longer direction coinciding with the array direction AD is formed.

The image forming portion 30 further includes a diffusion portion 34 on a surface on the side where the illumination units 10 are present. The diffusion portion 34 is located along the illumination target surface 32 and formed in, for example, a film shape. Alternatively, the diffusion portion 34 may be formed by providing fine projections and depressions on the illumination target surface 32. The diffusion portion 34 formed as above diffuses collimated illumination light before the illumination light passes through the image forming portion 30.

Light of an image formed in the image forming portion 30 goes incident on the planar mirror 40.

The planar mirror 40 is formed by vapor-depositing aluminum to form a reflection surface 41 on a surface of a base member made of synthetic resin, glass, or the like. The reflection surface 41 is a smooth plane. The planar mirror 40 reflects light of an image from the image forming portion 30 toward the concave mirror 42.

The concave mirror 42 is formed by vapor-depositing aluminum to form a reflection surface 43 on a surface of a base member made of synthetic resin, glass, or the like. The reflection surface 43 is a smooth inwardly-curved surface recessed at a center of the concave mirror 42. The concave mirror 42 reflects light of an image from the planar mirror 40 toward the windshield 3.

An opening is formed in the housing 50 between the concave mirror 42 and the windshield 3. A light-transmitting dustproof cover 52 is provided to the opening. Hence, light of an image from the concave mirror 42 passes through the dustproof cover 52 and is then reflected on the windshield 3. Light thus reflected on the windshield 3 is visible to an occupant as a virtual image VI.

The array of the illumination units 10 of the present embodiment will now be described in detail by using FIGS. 4 through 6 showing simple configurations in cross section in the array direction AD.

Referring to FIG. 4, an illumination width H with which one illumination unit 10 illuminates a corresponding spot on the illumination target surface 32 will be described. The light emitting element 12 is located on the focal point FP. Hence, Fno given as an F-number of the condensing portion 14 can be defined with the focal length f of the condensing portion 14 as: Fno=f/H. Hence, the illumination width H by collimated light is expressed as: H=f/Fno. As has been described above, an F-number of the condensing portion 14 is set to a range from Fmin to Fmax both inclusive. Consequently, the illumination width H can be within a range expressed as:

f/Fmax≤H≤f/Fmin (1).

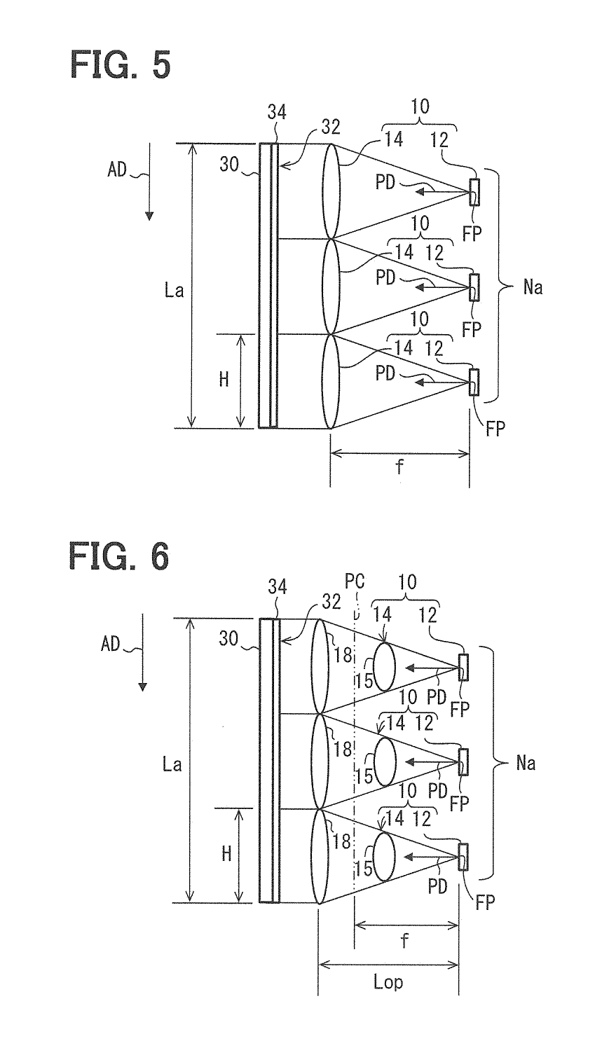

Referring to the array of the illumination units 10 of FIG. 5, let Na be the number of the light emitting elements 12 arrayed in the array direction AD, and La be a dimension of the illumination target surface 32 in the array direction AD. In order to illuminate the illumination target surface 32 in full width in the array direction AD without any blank, the light emitting elements 12 as many as Na=La/H are required. Hence, in the present embodiment, La/Na is set within a range expressed as:

f/Fmax≤La/Na≤f/Fmin (2).

A more detailed description will be given by using FIG. 6 showing the light emitting portions 14 of FIG. 5 by dividing each into the first lens element 15 and the second lens element 18. Let Lop be a distance between the light emitting element 12 and the second lens element 18 and d be a distance between the two lens elements 15 and 18. Further, let f1 be a focal length of the first lens element 15 and f2 be a focal length of the second lens element 18. Then, the focal length f of the condensing portion 14 satisfies an equation (3) as follows:

1/f=1/f1+1/f2−d/(f1·f2) (3).

The distance Lop is expressed as: Lop=d+f·(1−d/f2). Herein, f2 is large for d. Hence, by making an approximation, d/f2≈0, Lop can be expressed as: Lop=d+f. By rewriting Inequation (2) above by using Lop=d+f, it can be understood that La/Na is set within a range expressed as:

(Lop−d)/Fmax≤La/Na≤(Lop−d)/Fmin (4).

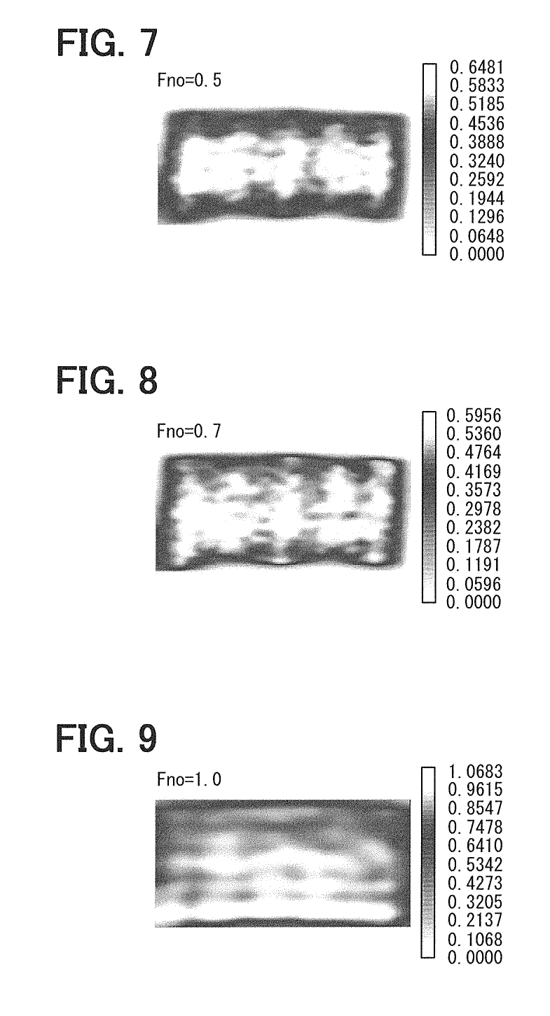

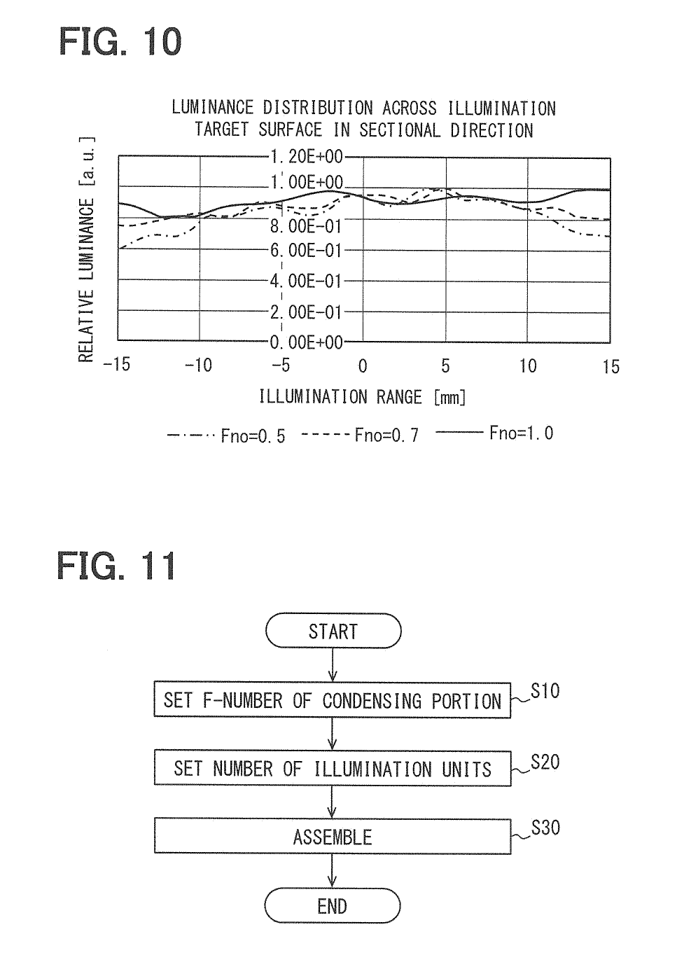

The following will describe luminance simulations for virtual image display conducted by the inventor by using the HUD apparatus 100 designed to satisfy Inequation (2) or (4) above. Various values are set as an F-number of the condensing portion 14 in the illumination unit 10 as follows: Fno=0.5 (FIG. 7), Fno=0.7 (FIG. 8), and Fno=1.0 (FIG. 9). Also, a luminance distribution across the illumination target surface 32 in cross section in the array direction AD is set forth in FIG. 10.

It can be understood from an examination of simulation results that in the case of Fno=1.0 where La/Na is close to a lower limit of Inequation (2) above, non-uniform luminance is restricted in comparison with a case where an F-number is less than 1.0. Meanwhile, the number of the arrayed light emitting elements 12 per dimension La may possibly be increased. By setting an F-number to a value out of the range expressed by Inequation (2) above to be greater than Fmax, the number of the arrayed light emitting elements 12 per dimension La, Na, increases sharply whereas a restricting effect of non-uniform luminance remains more or less the same as in the case of F=1.0.

On the contrary, in the case of Fno=0.5 where La/Na is close to an upper limit of Inequation (2) above, the number of the arrayed light emitting elements 12 per dimension La, Na, can be small in comparison with a case where an F-number is less than 0.5. Meanwhile, non-uniform luminance increases relatively. By setting an F-number to a value out of the range expressed by Inequation (2) above to be less than Fmin, non-uniform luminance gives considerable influence on visibility of a virtual image VI.

The following will describe a manufacturing method of the HUD apparatus 100 as above, and in particular, a method of arraying the illumination units 10 will be described chiefly by using a flowchart of FIG. 11.

Firstly, in Step S10 as an F-number setting step, an F-number of the condensing portion 14 corresponding to an emission angle distribution of the light emitting element 12 is set in the array of the illumination units 10. In the present embodiment, in particular, an F-number of the condensing portion 14 is set to a range from Fmin to Fmax both inclusive. When Step S10 ends, advancement is made to Step S20.

In Step S20 as a unit number setting step, a total number of the illumination units 10 is set according to the F-number to illuminate the entire illumination target surface 32 by the array of the illumination units 10. More specifically, by using the illumination width H obtained from the F-number and the focal distance f, a value of La/H is rounded up and a natural number thus found is set as the number of the arrayed light emitting elements 12, Na. After Step S20 ends, advancement is made to Step S30.

In Step S30, the array of the illumination units 10 is assembled. That is, the illumination units 10 are arrayed with respect to one another to illuminate the entire illumination target surface 32 when the respective illumination units 10 illuminate corresponding spots on the illumination target surface 32.

The HUD apparatus 100 is completed after the other elements are formed as described above.

Functional Effects

Functional effects of the first embodiment described above will now be described.

According to the first embodiment, illumination light emitted from the light emitting element 12 is condensed by the condensing portion 14 located face-to-face with the light emitting element 12 in each illumination unit 10. More specifically, a part of radiant flux including light in the peak direction PD of illumination light having the emission angle distribution, according to which emission intensity reaches maximum in the peak direction PD and decreases with distance from the peak direction PD, is condensed and thereby collimated by the condensing portion 14 in each illumination unit 10. In short, illumination light can be collimated by removing a portion where emission intensity is low with respect to the peak direction PD from the illumination light. Illumination light collimated by the condensing portion 14 as above illuminates a corresponding spot on the illumination target surface 32 in the image forming portion 30. Illumination made homogeneous across the entire illumination target surface 32 can be thus achieved by the illumination units 10 arrayed with respect to one another. Hence, non-uniform luminance of an entire image can be restricted. Consequently, non-uniform luminance of a virtual image VI displayed by projecting the image onto the windshield 3 can be reduced.

When an F-number is too small, a portion of illumination light where emission intensity is lower is also condensed by the condensing portion 14 which captures a part of radiant flux including light in the peak direction PD from the illumination light, in which case a reducing effect of non-uniform luminance becomes smaller. Conversely, when an F-number is too large, a large number of the illumination units 10 are required to illuminate the illumination target surface 32. By taking the foregoing into consideration, an F-number of the condensing portion 14 is set to a range from Fmin to Fmax both inclusive in the first embodiment. Hence, the required number of the illumination units 10 and a reducing effect of non-uniform luminance can be well balanced, which can in turn efficiently reduce non-uniform luminance of a virtual image VI.

According to the first embodiment, La/Na is set within the range expressed by Inequation (2) above. Hence, illumination on the illumination target surface 32 can be made homogeneous in a reliable manner while reducing an increase in the number of the light emitting elements 12 arrayed in the array direction AD, Na.

According to the first embodiment, illumination light is refracted on the composite optical surface 20 of the lens element 18 of the condensing portion 14. The composite optical surface 20 forms an alternating array structure, in which the condensing surfaces 21 collimating illumination light by condensing the illumination light and the deflection surfaces 22 continue alternately. In the alternating array structure, light emitted from the light emitting element 12 and captured by the corresponding condensing portion 14 is condensed by the condensing surface 21 or goes incident on the adjacent illumination unit 10 without being captured by the corresponding condensing portion 14. However, a part of such incident light may possibly be deflected again to the corresponding illumination unit 10 by the deflection surface 22. That is, not only light is mixed in the adjacent illumination unit 10, but also uncaptured light is used again. Hence, non-uniform luminance of a virtual image VI can be reduced.

According to the first embodiment, La/Na is set within the range expressed by Inequation (4) above. Hence, illumination on the illumination target surface 32 can be made homogeneous in a reliable manner by the condensing portion 14 having the lens elements 15 and 18 as two condensing elements while reducing an increase in the number of the light emitting elements 12 arrayed in the array direction AD, Na.

According to the first embodiment, the image forming portion 30 has the diffusion portion 34 located along the illumination target surface 32. Hence, even after illumination light is collimated by the condensing portion 14, light of an image can be diffused by the diffusion portion 34. Consequently, a view angle for a visible virtual image VI can be wider while efficiently reducing non-uniform luminance of the virtual image VI.

According to the manufacturing method of the HUD apparatus 100 of the first embodiment, an F-number of the condensing portion 14 is set according to an emission angle distribution of the light emitting element 12 in the illumination unit 10. A total number of the illumination units 10 is set according to the F-number set in the manner as above. By setting a total number of the illumination units 10, the entire illumination target surface 32 can be illuminated by the array of the illumination units 10. Hence, an F-number of each condensing portion 14 can be set to a suitable value and homogeneous illumination can be provided across the entire illumination target surface 32 by the illumination units 10 arrayed with respect to one another. Accordingly, the required number of the illumination units 10 and a reducing effect of non-uniform luminance of an entire image can be well balanced. Owing to the configuration as above, a HUD apparatus which reduces non-uniform luminance of a virtual image VI displayed by projecting an image onto the windshield 3 can be provided.

### Second Embodiment

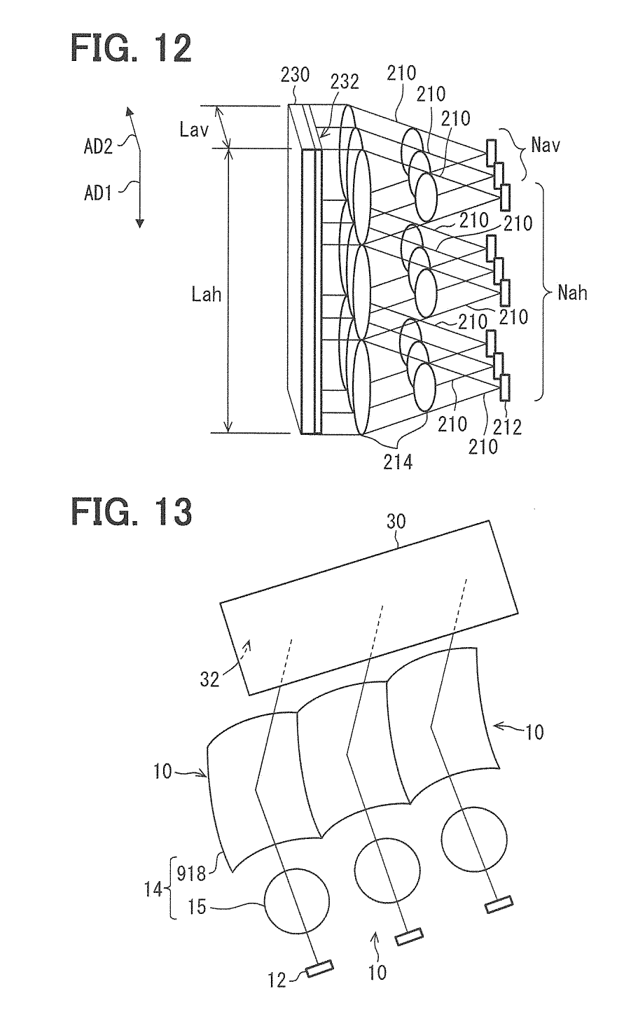

A second embodiment of the present disclosure as is shown in FIG. 12 is a modification of the first embodiment above. The second embodiment will chiefly describe a difference from the first embodiment above.

Illumination units 210 of the second embodiment are arrayed in two dimensional directions, namely, a first array direction AD1 and a second array direction AD2 crossing each other. In the second embodiment, in particular, the first array direction AD1 corresponds to a right-left direction of an illumination target surface 232 of an image forming portion 230 and the second array direction AD2 corresponds to a top-bottom direction of the illumination target surface 232. The first array direction AD1 and the second array direction AD2 are therefore substantially orthogonal to each other.

Let Nah be a number of light emitting elements 212 arrayed in the first array direction AD1 and Lah be a dimension of the illumination target surface 232 in the right-left direction in an array of the illumination units 210. Then, as with Inequations (2) and (4) of the first embodiment above, Lah/Nah is set within a range expressed as:

f/Fmax≤Lah/Nah≤f/Fmin (5)

which is rewritten as:

(Lop−d)/Fmax≤Lah/Nah≤(Lop−d)/Fmin (6).

Also, let Nav be the number of the light emitting elements 212 arrayed in the second array direction AD2 and Lay be a dimension of the illumination target surface 232 in the right-left direction in the array of the illumination units 210. Then, as with Inequations (2) and (4) of the first embodiment above, Lav/Nav is set within a range expressed as:

f/Fmax≤Lav/Nav≤f/Fmin (7)

which is rewritten as:

(Lop−d)/Fmax≤Lav/Nav≤(Lop−d)/Fmin (8).

Let Ns be a total number of the light emitting elements 212 arrayed in the respective array directions AD1 and AD2, and St be an area of the illumination target surface 232. Given Ns=Nah·Nav and St=Lah·Lav, then it can be understood from Inequations (5) and (7) above that St/Ns is set within a range expressed as:

f²/Fmax²≤St/Ns≤f²/Fmin² (9).

Likewise, it can be understood from Inequations (6) and (8) above that St/Ns is set within a range expressed as:

(Lop−d)²/Fmax²≤St/Ns≤(Lop−d)²/Fmin² (10).

In FIG. 12, the light emitting element 212 and a condensing portion 214 are indicated for only one illumination unit 210.

In a manufacturing method, a total number of the illumination units can be set by setting the numbers of the light emitting elements 212 arrayed in the array directions AD1 and AD2, Nah and Nav, respectively, in a same manner as in Step S20 of the first embodiment above.

In the second embodiment conFIGured as above, too, the condensing portion 214 captures a part of radiant flux including light in a peak direction PD from illumination light, and collimates the captured part of radiant flux by condensing the captured part of radiant flux. Hence, functional effects similar to the functional effects of the first embodiment above can be achieved.

According to the second embodiment, St/Ns is set within the range expressed by Inequation (9) above in the array of the illumination units 210 in two dimensional directions. Hence, illumination on the entire illumination target surface 232 can be made homogeneous in a reliable manner while restricting an increase in a total number of the light emitting elements 212, Ns.

According to the second embodiment, St/Ns is set within the range expressed by Inequation (10) above in the array of the illumination units 210 in two dimensional directions. Hence, illumination on the illumination target surface 232 can be made homogeneous in a reliable manner by the condensing portion 214 having two condensing elements while restricting an increase in a total number of the light emitting elements 212, Ns.

### Other Embodiments

While the above has described several embodiments of the present disclosure, an interpretation of the present disclosure is not limited to the embodiments above and the present disclosure can be implemented in various other embodiments or a combination of the various embodiments within the scope of the present disclosure.

More specifically, in a first modification, the second lens element 18 may not adopt the composite optical surface 20 forming the alternating array structure, in which the condensing surfaces 21 and the deflection surfaces 22 continue alternately. As an example, the second lens element 18 may collimate a part of radiant flux by condensing the part of radiant flux by using a smooth, curved refraction surface.

In a second modification, the condensing portion 14 may be formed of one lens element in each illumination unit 10. Alternatively, the condensing portion 14 may be formed of three or more lens elements in each illumination unit 10.

In a third modification, the condensing portion 14 may adopt a condensing element other than a lens element in each illumination unit 10. In a case shown in FIG. 13, the condensing portion 14 includes a reflection element as the condensing element.

In a fourth modification, the image forming portion 30 may omit the diffusion portion 34.

In a fifth modification, the light emitting element 12 only has to have an emission angle distribution, according to which emission intensity decreases with distance from the peak direction PD. Hence, a light emitting element with higher or lower directionality than the distribution shown in FIG. 3 is also adoptable.

In a sixth modification of the second embodiment above, the first array direction AD1 and the second array direction AD2 only have to cross each other and are not necessarily orthogonal to each other.

In a seventh modification, the present disclosure is also applicable to various mobile objects (transport devices) other than the vehicle 1, such as a ship and an air plane.

The head up display apparatus described above is mounted to the mobile object 1 and displays a virtual image visible to an occupant by projecting an image onto the projection member 3. The head up display apparatus includes the multiple illumination units 10 or 210 arrayed with respect to one another and providing illumination. The head up display apparatus also includes the image forming portion 30 or 230 having the illumination target surface 32 or 232 and forming an image when the respective illumination units illuminate corresponding spots on the illumination target surface. Each illumination unit has the light emitting element 12 or 212 emitting illumination light with an emission angle distribution, according to which emission intensity reaches maximum in the peak direction PD and decreases with distance from the peak direction PD. The illumination unit also has the condensing portion 14 or 214 located face-to-face with the light emitting element and capturing a part of radiant flux including light in the peak direction from illumination light and collimating the captured part of radiant flux by condensing the captured part of radiant flux.

According to the configuration as above, illumination light emitted from the light emitting element is condensed by the condensing portion located face-to-face with the light emitting element in the illumination unit. More specifically, a part of radiant flux including light in the peak direction of illumination light having an emission angle distribution, according to which emission intensity reaches maximum in the peak direction and decreases with distance from the peak direction, is condensed and thereby collimated by the condensing portion in the illumination unit. In short, illumination light can be collimated by removing a portion where emission intensity is low for the peak direction from the illumination light. Illumination light collimated by the condensing portion as above illuminates a corresponding spot on the illumination target surface in the image forming portion. Illumination made homogeneous across the entire illumination target surface can be achieved by the illumination units arrayed with respect to one another. Hence, non-uniform luminance of an entire image can be restricted. Consequently, non-uniform luminance of a virtual image displayed by projecting the image onto the projection member can be reduced.

According to another aspect of the present disclosure, the manufacturing method of the head up display apparatus described above includes the F-number setting step S10 in which an F-number of the condensing portion is set according to the emission angle distribution of the light emitting element in the array of the illumination units. The manufacturing method also includes the unit number setting step S20 in which a total number of the illumination units is set according to the F-number to illuminate the entire illumination target surface by the array of the illumination units.

When an F-number is too small, a portion of illumination light where emission intensity is lower is also condensed by the condensing portion which captures a part of radiant flux including light in the peak direction from illumination light, in which case a reducing effect of non-uniform luminance becomes smaller. Conversely, when an F-number is too large, a large number of the illumination units are required to illuminate the illumination target surface.

Hence, in the manufacturing method of the present disclosure, an F-number of the condensing portion is set according to the emission angle distribution of the light emitting element in the illumination unit. A total number of the illumination units is set according to the F-number set in the manner as above. By setting a total number of the illumination units as above, the entire illumination target surface is illuminated by the array of the illumination units. Hence, an F-number of each condensing portion can be set to a suitable value and homogeneous illumination can be provided across the entire illumination target surface by the illumination units arrayed with respect to one another. Accordingly, the required number of the illumination units and a reducing effect of non-uniform luminance of an entire image can be well balanced. Owing to the configuration as above, a HUD apparatus which reduces non-uniform luminance of a virtual image displayed by projecting an image onto the projection member can be provided.

While the present disclosure has been described according to the embodiments above, it should be understood that the present disclosure is not limited to the embodiments above and structures thereof. The present disclosure includes various modifications and alterations within the equivalent scope. In addition, various combinations and embodiments, as well as other combinations further including one element alone and more or less than one element are also within the scope and the idea of the present disclosure.

What is claimed is:

1. A head up display apparatus configured to be mounted to a mobile object and to display a virtual image visible to an occupant by projecting an image onto a projection member, the head up display apparatus comprising:
a plurality of illumination units arrayed one another and configured to provide illumination; and
an image forming portion having an illumination target surface and configured to form the image when the respective illumination units illuminate corresponding spots on the illumination target surface, wherein
each illumination unit includes:
a light emitting element configured to emit illumination light with an emission angle distribution, according to which emission intensity reaches maximum in a peak direction and decreases with distance from the peak direction; and
a condensing portion located face-to-face with the light emitting element and configured to capture a part of radiant flux including light in the peak direction from illumination light and to collimate the captured part of radiant flux by condensing the captured part of radiant flux, wherein
the condensing portion includes a lens element provided with a single and smooth incoming-side refractive surface and a single and smooth outgoing-side refractive surface.

2. The head up display apparatus according to claim 1, wherein
let Fmin be an F-number to condense, as the part of radiant flux, illumination light within a distribution range in which emission intensity of the light emitting element is at or above 50% of emission intensity in the peak direction, and Fmax be an F-number to condense, as the part of radiant flux, illumination light within a distribution range in which emission intensity of the light emitting element is at or above 90% of the emission intensity in the peak direction, then an F-number of the condensing portion in each illumination unit is in a range from Fmin to Fmax both inclusive.

3. The head up display apparatus according to claim 2, wherein
let Na be the number of light emitting elements arrayed in one array direction, La be a dimension of the illumination target surface in the array direction, and f be a focal length of the condensing portion, then La/Na is set within a range expressed as: f/Fmax≤La/Na≤f/Fmin.

4. The head up display apparatus according to claim 2 wherein
the respective illumination units are arrayed in two dimensional directions which are a first array direction and a second array direction crossing each other, and
let Ns be a total number of light emitting elements, St be an area of the illumination target surface, and f be a focal length of the condensing portion in an array of the illumination units, then St/Ns is set within a range expressed as: f²/Fmax²≤St/Ns≤f²/Fmin².

5. The head up display apparatus according to claim 1, wherein
the condensing portion includes, separately from the lens element, a second lens element configured to refract illumination light on a composite optical surface in each illumination unit, and
the composite optical surface forms an alternating array structure, in which condensing surfaces, which are configured to collimate illumination light by condensing the illumination light, and deflection surfaces, which are configured to deflect illumination light to a side opposite to refraction of illumination light condensed by the condensing surfaces, continue alternately.

6. The head up display apparatus according to claim 2, wherein
the condensing portion includes, separately from the lens element, a condensing element on a light path between the light emitting element and the corresponding spot in each illumination unit, and
let Na be the number of light emitting elements arrayed in one array direction, La be a dimension of the illumination target surface in the array direction, Lop be a distance between the light emitting element and one of the lens element and the condensing element on a side where the corresponding spot is present, and d be a distance between the lens element and the condensing element, then La/Na is set within a range expressed as: (Lop−d)/Fmax≤La/Na≤(Lop−d)/Fmin.

7. The head up display apparatus according to claim 2 wherein
the respective illumination units are arrayed in two dimensional directions which are a first array direction and a second array direction crossing each other;
the condensing portion has, separately from the lens element, a condensing element on a light path between the light emitting element and the corresponding spot in each illumination unit, and
let Ns be a total number of light emitting elements, St be an area of the illumination target surface, Lop be a distance between the light emitting element and one of the lens element and the condensing element on a side where the correspond spot is present, and d be a distance between the lens element and the condensing element, then St/Ns is set within a range expressed as: (Lop−d)²/Fmax²≤St/Ns≤(Lop−d)²/Fmin².

8. The head up display apparatus according to claim 6, wherein
the condensing element is a second lens element configured to refract illumination light on a composite optical surface, and
the composite optical surface forms an alternating array structure, in which condensing surfaces, which are configured to collimate illumination light by condensing the illumination light, and deflection surfaces, which are configured to deflect illumination light to a side opposite to refraction of illumination light condensed by the condensing surfaces, continue alternately.

9. The head up display apparatus according to claim 1, wherein
the image forming portion has a diffusion portion located along the illumination target surface and configured to diffuse illumination light collimated by the condensing portion.

10. A manufacturing method for a head up display apparatus configured to be mounted to a mobile object and to display a virtual image visible to an occupant by projecting an image onto a projection member, the head up display apparatus including a plurality of illumination units, which are arrayed one another to provide illumination, and an image forming portion, which has an illumination target surface and configured to form the image when the respective illumination units illuminate corresponding spots on the illumination target surface, each illumination unit including a light emitting element, which is configured to emit illumination light with an emission angle distribution according to which emission intensity reaches maximum in a peak direction and decreases with distance from the peak direction, and a condensing portion, which is located face-to-face with the light emitting element and configured to capture a part of radiant flux including light in the peak direction from illumination light and to collimate the captured part of radiant flux by condensing the captured part of radiant flux, the condensing portion including a lens element provided with a single and smooth incoming-side refractive surface and a single and smooth outgoing-side refractive surface, the manufacturing method comprising:
setting, in an F-number setting step, an F-number of the condensing portion according to the emission angle distribution of the light emitting element in an array of the illumination units; and
setting, in a unit number setting step, a total number of the illumination units according to the F-number to illuminate the illumination target surface entirely by the array of the illumination units.
